(19) United States
(12) Patent Application Publication
(10) Pub. No.: US 2013/0120345 A1
(43) Pub. Date: May 16, 2013

(54) PLASMA DISPLAY AND DRIVING METHOD THEREOF

(71) Applicant: Jin-Ho Yang, Yongin-si (KR)

(72) Inventor: Jin-Ho Yang, Yongin-si (KR)

(21) Appl. No.: 13/419,243

(22) Filed: Mar. 13, 2012

(30) Foreign Application Priority Data
Nov. 15, 2011 (KR) 10-2011-0119023

(51) Int. Cl. G09G 3/28; G06F 3/038

(52) U.S. Cl. 345/212; 345/60

(57) ABSTRACT

In a plasma display, a first transistor is coupled between a low voltage terminal of a scan circuit and a power source configured to supply a scan voltage, and a second transistor is coupled between the low voltage terminal and the first transistor. A third transistor is coupled to the low voltage terminal, and a capacitor is coupled between the third transistor and a node between the first and second transistors. In addition, a fourth transistor is coupled between the low voltage terminal and a ground terminal. By utilizing the capacitor, power consumption of a transistor can be reduced, and accordingly, heat dissipation of the transistor also can be reduced.

### CROSS-REFERENCE TO RELATED APPLICATION

This application claims priority to and the benefit of Korean Patent Application No. 10-2011-0119023 filed in the Korean Intellectual Property Office on Nov. 15, 2011, the entire contents of which are incorporated herein by reference.

### BACKGROUND

(a) Field

Embodiments of the present invention relate to a plasma display and a driving method thereof.

(b) Description of the Related Art

A plasma display device includes a plurality of display electrodes and a plurality of discharge cells defined by the plurality of display electrodes. In order to display images, the discharge cells to be turned on (hereinafter referred to as “on cells”) and the discharge cells to be turned off (hereinafter referred to as “off cells”) are selected from the plurality of discharge cells, and then the on cells are discharged.

Before the selection of the on cells or the off cells, the plasma display gradually increases a voltage of a display electrode for generating a weak discharge in the discharge cells, and gradually decreases the voltage of the display electrode for generating a weak discharge in the discharge cells, such that a charge state of the discharge cells are reset by the weak discharge. In order to gradually increase the voltage of the display electrode, the plasma display repeats an on/off operation of a transistor connected to the display electrode or controls a current supplied to a gate of the transistor.

However, when the voltage of the display electrode is gradually decreased, a current is supplied to a capacitive component formed by the display electrode through the transistor. Therefore, the transistor continuously consumes power due to the current, and accordingly heat dissipation of the transistor is increased.

The above information disclosed in this Background section is only for enhancement of understanding of the background of the invention, and therefore it may contain information that does not form the prior art that is already known in this country to a person of ordinary skill in the art.

### SUMMARY

Embodiments of the present invention are directed to a plasma display that can reduce heat dissipation of a transistor, and a driving method thereof.

According to an exemplary embodiment of the present invention, a plasma display is provided. The plasma display includes a scan electrode, a scan circuit, a first transistor, and a falling reset driver. The scan circuit includes a high voltage terminal and a low voltage terminal and being configured to set a voltage of the scan electrode as a voltage of the high voltage terminal or a voltage of the low voltage terminal. The first transistor is coupled between the low voltage terminal and a first power source configured to supply a first voltage, and includes a first terminal of which a voltage corresponds to the voltage of the scan electrode and a second terminal of which a voltage corresponds to the first voltage. The falling reset driver includes a second transistor coupled in series with the first transistor between the low voltage terminal and the first terminal of the first transistor, a third transistor coupled between the first terminal of the first transistor and the low voltage terminal, and a first capacitor. In this embodiment, the falling reset driver is configured to gradually decrease the voltage of the scan electrode to a second voltage that is higher than the first voltage through the first capacitor by turning on the first transistor during a first falling period of a first period of a reset period, and gradually decrease the voltage of the scan electrode to the first voltage by concurrently turning on the first transistor and the second transistor during a second falling period of the first period.

The plasma display further includes a first gate driver configured to turn on the second transistor depending on a voltage of the first terminal of the first transistor.

The falling reset driver may be configured to gradually increase the voltage of the scan electrode to the second voltage through the first capacitor by turning on the third transistor during a first rising period after the second falling period in the first period.

The falling reset driver may further include a fourth transistor coupled between the low voltage terminal and a second power source configured to supply a third voltage that is higher than the first voltage, and the fourth transistor may be configured to increase the voltage of the scan electrode from the second voltage to the third voltage by turning on the fourth transistor during a second rising period after the first rising period in the first period.

The plasma display may further include a first gate driver configured to turn on the third transistor by a control signal during the first rising period and a second gate driver configured to turn on the fourth transistor by the control signal during the second rising period.

The falling reset driver may further include a first diode of which an anode is coupled to the first power source and a cathode is coupled to the first capacitor.

The falling reset driver may further include a diode configured to block a current path including the first capacitor, the first transistor, and the second transistor.

According to another exemplary embodiment of the present invention, a driving method of a plasma display is provided. The plasma display includes a scan electrode, a scan circuit having a high voltage terminal and a low voltage terminal and configured to set a voltage of the scan electrode to a voltage of the high voltage terminal or a voltage of the low voltage terminal, and a first transistor coupled between the low voltage terminal and a first power source configured to supply a first voltage. The driving method of the plasma display includes: electrically connecting the low voltage terminal to the scan electrode during a first period of a reset period; gradually decreasing the voltage of the scan electrode to a second voltage that is higher than the first voltage through a capacitor coupled between the low voltage terminal and the first transistor by turning on the first transistor during a first falling period in the first period; and gradually decreasing the voltage of the scan electrode from the second voltage to the first voltage by concurrently turning on the first transistor and the second transistor coupled between the low voltage terminal and the first transistor during a second falling period in the first period.

### BRIEF DESCRIPTION OF THE DRAWINGS

FIG. 1 is a schematic block diagram of a plasma display according to an exemplary embodiment of the present invention.

FIG. 2 schematically shows driving waveforms of the plasma display according to an exemplary embodiment of the present invention.

FIG. 3 is a schematic circuit diagram of a scan electrode driver according to an exemplary embodiment of the present invention.

FIG. 4 shows a signal timing and a voltage of a falling reset driver in a preset period according to an exemplary embodiment of the present invention.

FIG. 5 and FIG. 6 show a current path of the falling reset driver of each period shown in FIG. 4.

FIG. 7 shows signal timings and voltages of a scan driver and a falling reset driver of a falling period and an address period of a reset period according to an exemplary embodiment of the present invention.

FIG. 8 shows a gate driver of a transistor Yfr of FIG. 3.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements, but not the exclusion of any other elements.

Hereinafter, a plasma display and a driving method thereof according to an exemplary embodiment of the present invention will be described with reference to the accompanying drawings.

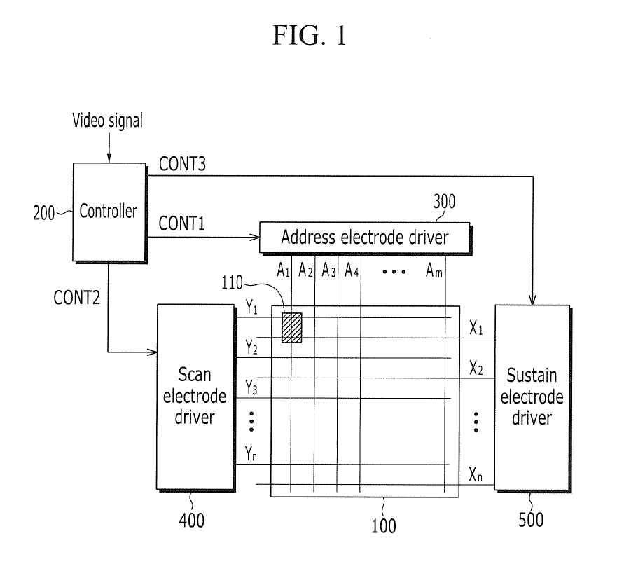

FIG. 1 is a schematic block diagram of a plasma display according to an exemplary embodiment of the present invention.

Referring to FIG. 1, the plasma display includes a plasma display panel 100, a controller 200, an address electrode driver 300, a scan electrode driver 400, and a sustain electrode driver 500.

The plasma display panel 100 includes a plurality of display electrodes Y1 to Yn and X1 to Xn, a plurality of address electrodes (hereinafter, referred to as A electrodes) A1 to Am, and a plurality of discharge cells.

The plurality of display electrodes Y1 to Yn and X1 to Xn include a plurality of scan electrodes (hereinafter, referred to as Y electrodes) Y1 to Yn, and a plurality of sustain electrodes (hereinafter, referred to as X electrodes) X1 to Xn. The Y electrodes Y1 to Yn and the X electrodes X1 to Xn extend substantially in a row direction, and the A electrodes A1 to Am extend substantially in a column direction and are substantially parallel with each other. The Y electrodes Y1 to Yn and the X electrodes X1 to Xn may correspond to each other one by one. Alternatively, two X electrodes X1 to Xn may correspond to one Y electrode Y1 to Yn, or two Y electrodes Y1 to Yn may correspond to one X electrode X1 to Xn. In this case, discharge cells 110 are formed in a space defined by the A electrodes A1 to Am, the Y electrodes Y1 to Yn, and the X electrodes X1 to Xn.

The structure of the plasma display panel 100 is just one example, and according to an embodiment of the present invention, the plasma display panel 100 may have another structure.

The controller 200 receives a video signal and an input control signal for controlling the display of the video signal. The video signal contains information on the luminance of each discharge cell 110, and the luminance of each discharge cell 110 may be expressed as one of gray-levels of a set or predetermined number or weight. An example of the input control signal includes a vertical synchronization signal, a horizontal synchronization signal, etc.

The controller 200 segments or divides one frame for displaying the video into a plurality of sub-fields each having a luminance weight, and at least one sub-field includes a reset period, an address period, and a sustain period. The controller 200 generates an A electrode driving control signal CONT1, a Y electrode driving control signal CONT2, and an X electrode driving control signal CONT3 by processing the video signal and the input control signal to be suitable for the plurality of sub-fields. In addition, the controller 200 outputs the A electrode driving control signal CONT1 to the address electrode driver 300, outputs the Y electrode driving control signal CONT2 to the scan electrode driver 400, and outputs the X electrode driving control signal CONT3 to the sustain electrode driver 500.

Further, the controller 200 converts the input video signal corresponding to each discharge cell into sub-field data representing emission/non-emission of each discharge cell 110 in the plurality of sub-fields, and the A electrode driving control signal CONT1 includes the sub-field data.

The scan electrode driver 400 sequentially applies a scan pulse to the Y electrodes Y1 to Yn during the address period in accordance with the Y electrode driving control signal CONT2. The address electrode driver 300 applies a voltage for discriminating an on cell and an off cell from each other to the A electrodes A1 to Am in the plurality of discharge cells connected to the Y electrode to which the scan voltage is applied in accordance with the A electrode driving control signal CONT1.

When the on cells and the off cells are discriminated from each other during the address period, the scan electrode driver 400 and the sustain electrode driver 500 alternately apply sustain discharge pulses to the Y electrodes Y1 to Yn and the X electrodes X1 to Xn at a frequency corresponding to a luminance weight of each sub-field during the sustain period in accordance with the Y electrode driving control signal CONT2 and the X electrode driving control signal CONT3.

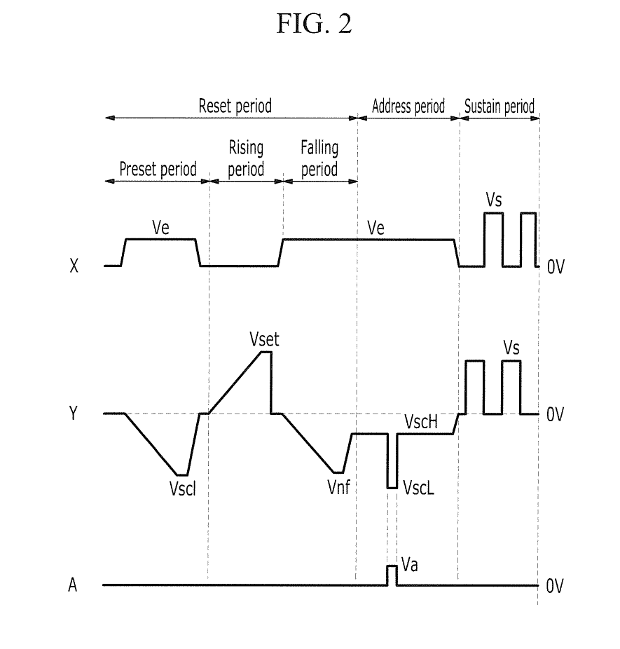

FIG. 2 schematically shows driving waveforms of the plasma display according to an exemplary embodiment of the present invention.

FIG. 2 illustrates one subfield among a plurality of subfields for convenience, and driving waveforms respectively applied to a Y electrode, an X electrode, and an A electrode forming one discharge cell will be described.

Referring to FIG. 2, in a preset period of a reset period, the sustain electrode driver 400 applies a voltage Vpx to the X electrode, and the scan electrode driver 500 gradually decreases a voltage of the Y electrode from a reference voltage (e.g., a ground voltage of FIG. 2) to a voltage Vpy. In addition, the address electrode driver 300 applies the reference voltage to the A electrode. In this case, a difference between the voltage applied to the X electrode and the voltage applied to the Y electrode during the preset period is set to satisfy |Vpx−Vpy|>|Ve−Vnf|.

Here, a (Ve−Vnf) voltage is set to be close to a discharge firing voltage between the X electrode and the Y electrode such that a wall voltage between the X electrode and the Y electrode becomes almost 0 V. Thus, when the absolute value of the (Vpx−Vpy) voltage is larger than the absolute value of the (Ve−Vnf) voltage, all the cells are discharged such that positive charges may be formed at the Y electrode and negative charges may be formed at the X electrode.

FIG. 2 illustrates that a voltage Ve is used as the voltage Vpx and a voltage VscL is used as the Vpy voltage to reduce the number of additional power sources.

In a rising period of the reset period, the scan electrode driver 400 gradually increases the voltage of the Y electrode from the reference voltage to the voltage Vset and then maintains the voltage of the Y electrode at the voltage Vset for a constant time period while the address electrode driver 300 and the sustain electrode driver 500 apply the reference voltage to the A and X electrodes. For example, the scan electrode driver 400 may increase the voltage of the Y electrode in a ramp pattern. While the voltage of the Y electrode is gradually increased, a weak discharge occurs between the Y electrode and the X electrode, and between the Y electrode and the A electrode, and accordingly negative charges may be formed at the Y electrode and positive charges may be formed at the X and A electrodes.

Subsequently, in a falling period of the reset period, the scan electrode driver 400 gradually decreases the voltage of the Y electrode from the reference voltage to a voltage Vnf while the address electrode driver 300 and the sustain electrode driver 500 apply the reference voltage and the voltage Ve respectively to the A electrode and the X electrode. For example, the scan electrode driver 400 may decrease the voltage of the Y electrode in the ramp pattern. While the voltage of the Y electrode is gradually decreased, a weak discharge occurs between the Y electrode and the X electrode, and between the Y electrode and the A electrode, and accordingly the negative charges formed at the Y electrode and the positive charges formed at the X and A electrodes may be erased. Accordingly, the discharge cell 110 may be reset. In this case, the voltage Vnf may be set to a negative voltage, and the voltage Ve may be set to a positive voltage. In addition, a difference (Ve−Vnf) between the voltage Ve and the voltage Vnf is set to a value close to a discharge firing voltage between the Y electrode and the X electrode such that the reset discharge may set a discharge cell to an off cell. Further, the voltage of the Y electrode may be gradually decreased from a voltage that is different from the reference voltage in the falling period.

In an address period, in order to determine or set on cells and off cells, the scan electrode driver 400 sequentially applies a scan pulse having the voltage VscL (e.g., a scan voltage) to the plurality of scan electrodes Y1 to Yn of FIG. 1 while the sustain electrode driver 500 applies the voltage Ve to the X electrodes. Concurrently (e.g., simultaneously), the address electrode driver 300 applies a voltage Va to an A electrode that is connected an on cell among the plurality of discharge cells formed by the Y electrode to which the VscL voltage is applied. Accordingly, an address discharge occurs in a discharge cell formed by the A electrode applied with the voltage Va and the Y electrode applied with the voltage VscL such that positive charges may be formed at the Y electrode, and negative charges may be formed at the A and X electrodes. In addition, the scan electrode driver 400 may apply a voltage VscH (e.g., a non-scan voltage) that is higher than the voltage VscL to a Y electrode to which the voltage VscL is not applied, and the address electrode driver 300 may apply a ground voltage to an A electrode to which the voltage Va is not applied. In this case, the voltage VscL may be a negative voltage, and the voltage Va may be a positive electrode.

During the sustain period, the scan electrode driver 400 and the sustain electrode driver 500 alternately apply sustain discharge pulses with a high voltage Vs and a low voltage (for example, a ground voltage) to the Y and X electrodes such that they are opposite in phase to each other. That is, when a high voltage Vs is applied to the Y electrode while the low voltage is applied to the X electrode, sustain discharge occurs in on-cells due to the difference between the high voltage Vs and the low voltage. Thereafter, when the low voltage is applied to the Y electrode and the high voltage Vs is applied to the X electrode, the sustain discharge may again occur in the on-cells due to the difference between the high voltage Vs and the low voltage. This operation is repeated during the sustain period so that the number of sustain discharges correspond to the luminance weight value of the corresponding subfield. Alternatively, while a ground voltage is applied to one of the Y and X electrodes (for example, the X electrode), the sustain discharge pulses with the Vs voltage and the −Vs voltage may be alternately applied to the other electrode (for example, the Y electrode).

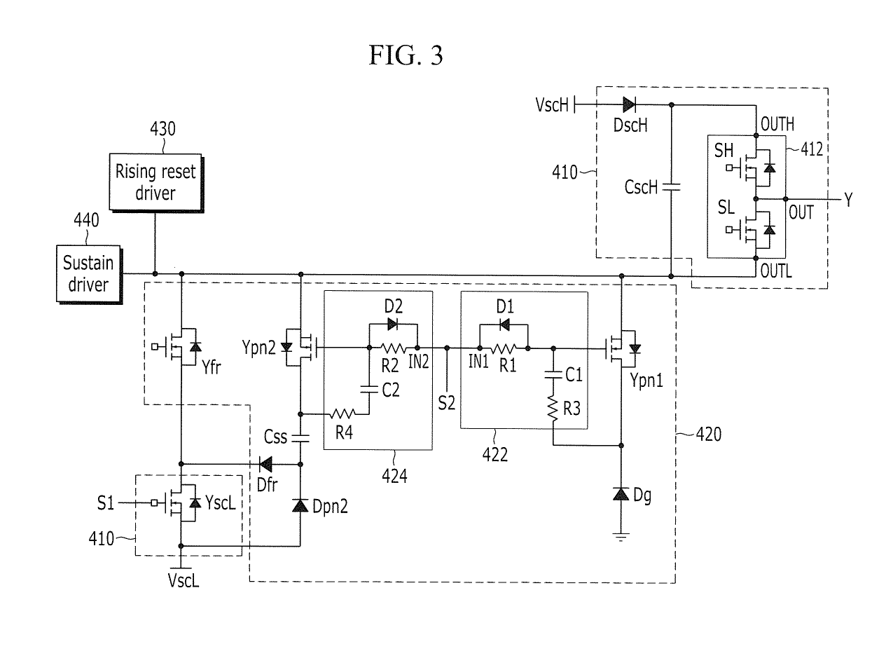

The scan electrode driver 400 according to an exemplary embodiment of the present invention will now be described with reference to FIG. 3.

FIG. 3 is a schematic circuit diagram of the scan electrode driver 400 according to an exemplary embodiment of the present invention.

Referring to FIG. 3, the scan electrode driver 400 includes a scan driver 410, a falling reset driver 420, a rising reset driver 430, and a sustain driver 440.

The scan driver 410 includes a scan circuit 412, a capacitor CscH, a diode DscH, and a transistor YscL. The scan circuit 412 includes a high voltage terminal OUTH, a low voltage terminal OUTL, and an output terminal OUT. In addition, the scan circuit 412 may include two transistors SH and SL. The scan circuit 412 sequentially applies the scan pulse having the voltage VscL to the plurality of Y electrodes during the address period.

The falling reset driver 420 includes transistors Yfr, Ypn1, and Ypn2, diodes Dfr, Dpn2, and Dg, a capacitor Css, and gate drivers 422 and 424. The falling reset driver 420 gradually decreases the voltage of the Y electrode during the preset period and the falling period of the reset period and then increases the voltage of the Y electrode to a set or predetermined voltage for the operation during the next period.

The rising reset driver 430 gradually increases the voltage of the Y electrode during the rising period of the reset period.

The sustain driver 440 alternately applies the voltage Vs and 0 V to the Y electrode during the sustain period. As shown in FIG. 3, depending on a connection method, the sustain driver 440 may be directly connected to the low voltage terminal OUTL, or all elements of the sustain driver 440 or a part of the elements may be connected to the low voltage terminal OUTL through a drain terminal of the transistor Ypn1.

In further detail, in the scan driver 410, a drain of the transistor YscL is connected to the low voltage terminal OUTL (e.g., via the transistor Yfr), and a source thereof is connected to a power source VscL that supplies the voltage VscL. In this case, a capacitor (not shown) may be connected between the gate of the transistor YscL and the low voltage terminal OUTL for gradually changing the voltage of the low voltage terminal OUTL.

The capacitor CscH is connected between the high voltage terminal OUTH and the low voltage terminal OUTL of the scan circuit 412, and a power source VscH for supplying a voltage VscH is connected to the high voltage terminal OUTH of the scan circuit 412. In this case, the diode DscH may be connected between the power source VscH and the high voltage terminal OUTH to block a current path from the capacitor CscH to the power source VscH. The capacitor CscH is charged with a voltage (VscH−VscL) that corresponds to a difference between the voltage VscH and the voltage VscL when the transistor YscL is turned on.

A source of the transistor SH of the scan circuit 412 is connected to the high voltage terminal OUTH, and a drain thereof is connected to the output terminal OUT. A drain of the transistor SL is connected to the output terminal OUT, and a source thereof is connected to the low voltage terminal OUTL. Depending upon the turning on/off of the transistors SH and SL, the scan circuit 412 sets the voltage of the Y electrode to be the voltage of the high voltage terminal OUTH or the voltage of the low voltage terminal OUTL.

One scan circuit 412 may correspond to one Y electrode, and a plurality of scan circuits respectively corresponding to the plurality of Y electrodes (i.e., Y1 to Yn of FIG. 1) may be formed in the scan driver 410. In this case, some of the plurality of scan circuits 412 may be formed as an integrated circuit (IC) while sharing the high and low voltage terminals OUTH and OUTL.

During the address period, the transistor YscL is turned on in response to a control signal S1 such that the voltage of the low voltage terminal OUTL of the scan circuit 412 becomes the voltage VscL. In addition, the transistors SL of the plurality of scan circuits 412 are sequentially turned on, and thus the plurality of scan circuits 412 sequentially apply the voltage of the low voltage terminal OUTL to the plurality of Y electrodes. The transistor SH of a scan circuit 412 of which the transistor SL is not turned on among the plurality of scan circuits 412, is turned on such that the transistor SH applies the voltage VscH of the high voltage terminal OUTH to the corresponding Y electrode.

In the falling reset driver 420, a drain of the transistor Yfr is connected to the low voltage terminal OUTL of the scan circuit 412, and a source thereof is connected to the drain of the transistor YscL. The transistor Yfr is turned on or turned off according to a drain voltage Vd of the transistor YscL.

A source of the transistor Ypn1 is connected to the low voltage terminal OUTL of the scan circuit 412, a drain thereof is connected to a cathode of the diode Dg, and an anode of the diode Dg is connected to a ground terminal.

A source of the transistor Ypn2 is connected to the low voltage terminal OUTL of the scan circuit 412, and a drain thereof is connected to one terminal of the capacitor Css. The other terminal of the capacitor Css is connected to an anode of the diode Dfr and a cathode of the diode Dpn2. A cathode of the diode Dfr is connected to the drain of the transistor YscL, and the anode of the diode Dpn2 is connected to the power source VscL. The capacitor Css is charged with a voltage of about |VscL/2|. When the transistor Ypn2 is turned on and the transistor Yfr is not turned off, the capacitor Css can be discharged through a current path from the capacitor Css through the transistor Ypn2 and the transistor Yfr then back to the capacitor Css. However, the diode Dfr blocks the current path through the capacitor Css, the transistor Ypn2, the transistor Yfr, and the capacitor Css to thereby prevent the capacitor Css from being discharged. The diode Dpn2 maintains a voltage of the other terminal of the capacitor Css to be higher than the voltage VscL. Here, the diodes Dpn2 and Dfr may not be used if the turn-on/off of the transistor Yfr can be accurately controlled. When the diodes Dpn2 and Dfr are not used, the drain of the transistor YscL is connected to the other terminal of the capacitor Css.

During a preset period and a falling period of the reset period, the transistor YscL is turned on by the control signal S1 such that the voltage of the Y electrode is gradually decreased. In addition, during the preset period and the falling period of the reset period, the transistor Yfr is turned on according to the drain voltage of the transistor YscL while the voltage of the Y electrode is gradually decreased such that the voltage of the Y electrode can be further decreased to the voltage VscL. In this case, the capacitor Css is charged with energy while the voltage of the Y electrode is decreased through the transistor YscL, and the capacitor Css may be charged with a voltage of |VscL|/2 through repetition of normal operation. The capacity of the capacitor Css may be 5 times greater than that of the panel capacitor so as to maintain a corresponding voltage. Here, the panel capacitor may be a capacitive component formed by the X and Y electrodes and the Y and A electrodes.

The transistors Ypn1 and Ypn2 are driven to increase the voltage of the Y electrode to a set or predetermined voltage (e.g., a ground voltage) after being decreased to the YscL voltage during the preset period of the reset period.

The gate driver 422 includes an input terminal IN1, resistors R1 and R3, a capacitor C1, and a diode D1. The gate driver 422 is configured to turn on the transistor Ypn1 according to a control signal S2 that is input to the input terminal IN1 to control the transistor Ypn1 to gradually change the voltage of the Y electrode. The gate driver 424 includes an input terminal IN2, resistors R2 and R4, a capacitor C2, and a diode D2. The gate driver 424 is configured to turn on the transistor Ypn2 according to the control signal S2 input to the input terminal IN2 to gradually change the voltage of the Y electrode.

One terminal of the resistor R1 is connected to a gate of the transistor Ypn1, and the other terminal of the resistor R1 is connected to the input terminal IN1 to which the control signal S2 is input. An anode of the diode D1 is connected to the gate of the transistor Ypn1, and the cathode of the diode D1 is connected to the input terminal IN1. The capacitor C1 and the resistor R3 are coupled in series between the gate and the drain of the transistor Ypn1.

One terminal of the resistor R2 is connected to a gate of the transistor Ypn2, and the other terminal of the resistor R2 is connected to the input terminal IN2 to which the control signal S2 is input. An anode of the diode D2 is connected to a gate of the transistor Ypn2, and a cathode of the diode D2 is connected to the input terminal IN2. The capacitor C2 and the resistor R4 are coupled in series between the gate and the drain of the transistor Ypn2.

Here, the values of the resistors R1 and R2 and the capacitors C1 and C2 are set such that the transistor Ypn2 is turned on first in response to the control signal S2, and then the transistor Ypn1 is turned on after a predetermined time gap.

In further detail, the capacitors C1 and C2 gradually increase or decrease the gate voltages of the transistors Ypn1 and Ypn2 to control the transistors Ypn1 and Ypn2 not to be rapidly turned on. That is, currents Ipn1 and Ipn2 respectively flowing through the capacitors C1 and C2 are represented by Equation 1 and Equation 2.

i) C1_cap*dV_{—}C1/dt=Ipn1=(Vg−Vth)/R1_reg [Equation 1]

i) C2_cap*dV_{—}C2/dt=Ipn2=(Vg−Vth)/R2_reg [Equation 2]

In Equation 1 and Equation 2, dV_C1 and dV_C2 respectively denote voltages between the terminals of the capacitors C1 and C2, and dt denotes a time difference. C1_cap and C2_cap respectively denote capacitances of the capacitors C1 and C2. Vg denotes a voltage of the control signal S2, Vth denotes a threshold voltage of the transistors Ypn1 and Ypn2, and R1_reg and R2_reg respectively denote resistance values of the resistors R1 and R2. Equation 3 and Equation 4 are established from Equation 1 and Equation 2.

i) dV_{—}C1/dt=Ipn1=(Vg−Vth)/(R1_reg*C1_cap) [Equation 3]

i) dV_{—}C2/dt=Ipn2=(Vg−Vth)/(R2_reg*C2_cap) [Equation 4]

That is, a variation speed or rate dV_C1/dt, dV_C2/dt of the voltage between the terminals of the capacitors C1 and C2 is inversely proportional to a resistance value of the resistors R1 and R2 and capacitance of the capacitors C1 and C2. In addition, a variation speed dV_C1/dt, dV_C2/dt of the voltage between the terminals of the capacitors C1 and C2 is the same as a voltage variation speed of the low voltage terminal OUTL.

Here, when the resistance value of the resistor R1 is 2*R2_reg and the capacitance of the capacitor C1 is set to be the same as that of the capacitor C2, the transistor Ypn2 is first turned on, and then the transistor Ypn1 may be turned on even though the transistors Ypn1 and Ypn2 are applied with the same control signal S2.

That is, the transistor Ypn1 is not turned on at the same time as the transistor Ypn2 because charging of the capacitor C1 is slowly performed while the transistor Ypn2 is turned on, and the voltage of the low voltage terminal OUTL is increased with twice the speed. When the voltage of the low voltage terminal OUTL is increased by a voltage equal to the VscL voltage+charged voltage of the capacitor Css and a voltage between the terminals of the capacitor C1 reaches a condition that turns on the transistor Ypn1, the voltage of the low voltage terminal OUTL is increased to the ground voltage while the transistor Ypn1 is being turned on.

For example, capacitance of the capacitors C1 and C2 is 0.33 nF, a resistance value of the resistor R1 is 680 ohm, a resistance value of the resistor R2 is 330 ohm, Vg is 15 V, and a threshold voltage of the transistors Ypn1 and Ypn2 is 4 V. In this case, a voltage slope (variation speed) of the transistor Ypn2 is 110 V/μs [i.e., (15 V−4 V)/(330 ohm*0.33 nF)], and a voltage slope (variation speed) of the transistor Ypn1 is 49V/μs [i.e., (15 V−4 V)/(680 ohm*0.33 nF)]. When the VscL voltage is −200 V, the transistor Ypn2 is turned on and becomes operating in about 1 μs, and the transistor Ypn1 is turned on after about 2 μs from when the control signal S2 becomes high level and increases the voltage of the low voltage terminal OUTL to the ground voltage for about 2 μs. In a practical circuit, capacitance exists between drains and sources of the transistors Ypn1 and Ypn2, and accordingly a voltage slope of the transistors Ypn1 and Ypn2 has a slower slope by the internal capacitance.

In another embodiment, the capacitance of the capacitor C1 may be set to be larger than that of the capacitor C2, and the resistor R1 and the resistor R2 may have the same resistance value.

As described, when the resistors R1 and R2 and the capacitors C1 and C2 have the suitable values that turn on the transistor Ypn2 first and turn on the transistor Ypn1 after a set or predetermined time gap, the transistor Ypn2 is first turned on so that the voltage of the Y electrode is decreased to the VscL voltage during a preset period of the reset period, and then the transistor Ypn1 is turned on after the voltage of the Y electrode has been increased using the voltage charged in the capacitor Css so that the voltage of the Y electrode can be further increased to the ground voltage. The operation may be performed after the voltage of the Y electrode is decreased to the Vnf voltage during the falling period of the reset period.

In addition, the transistor Ypn2 is first turned on and then the transistor Ypn1 is turned on after a set or predetermined time gap due to the values of the resistors R1 and R2 and the capacitors C1 and C2 in order to save the cost of a gate driver (not shown) that turns on/off the transistors Ypn1 and Ypn2, and the resistors R1 and R2 and the capacitors C1 and C2 may not be used when the turn-on timing of each of the transistors Ypn1 and Ypn2 is controlled using a control signal that is different from a control signal of a gate driver of each of the transistors.

Operation of the falling reset driver 420 will now be described in further detail.

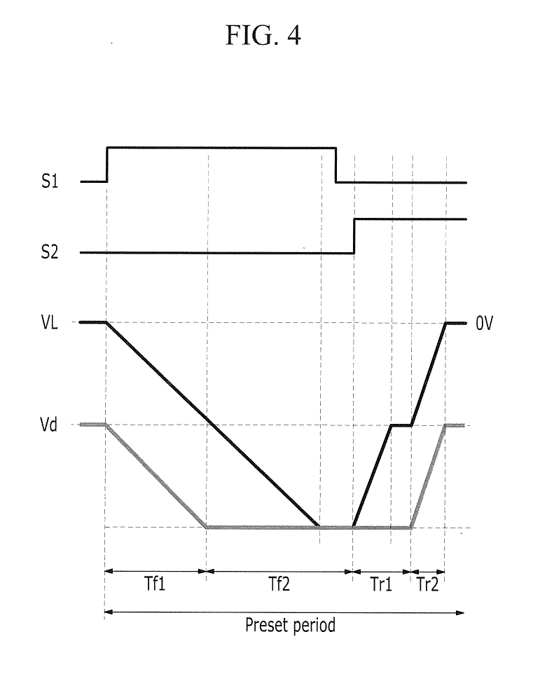

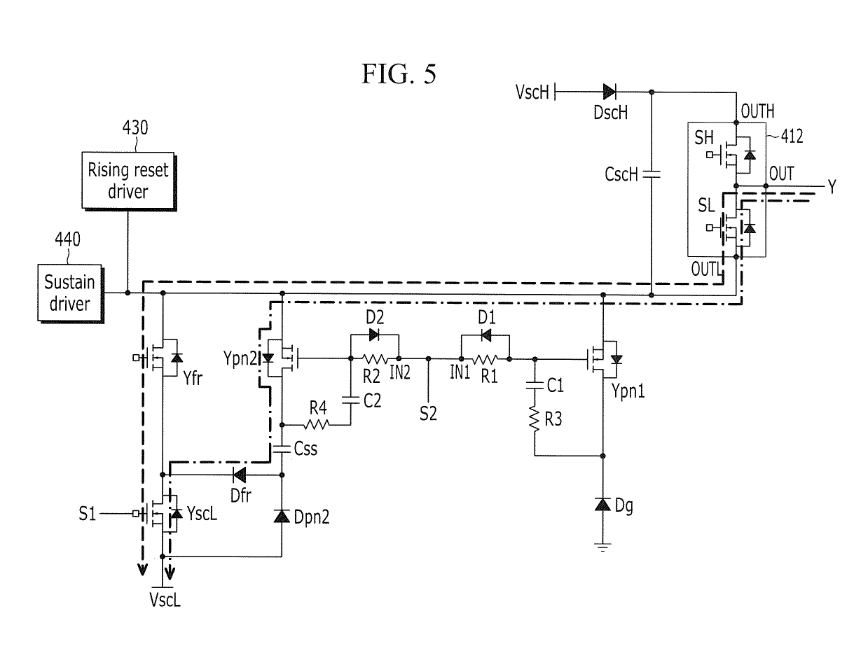

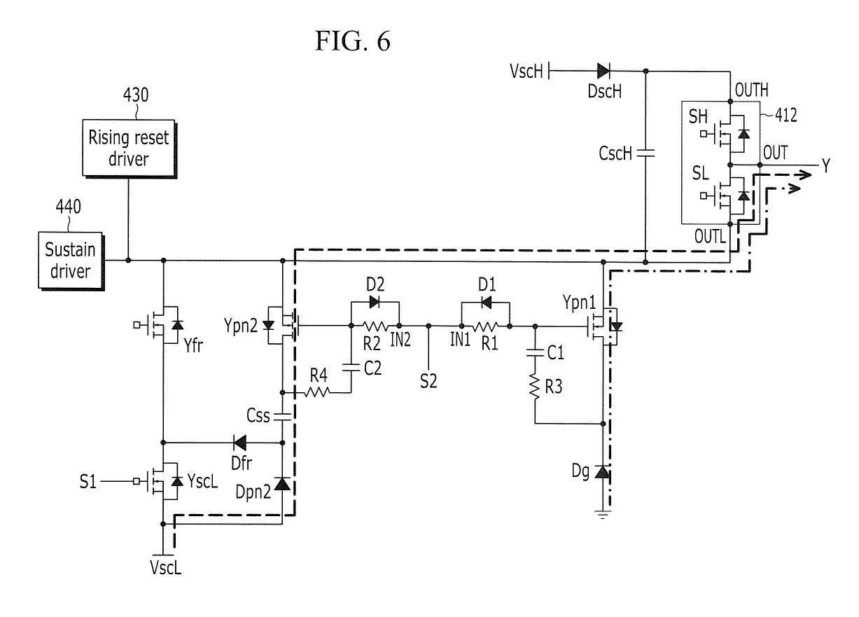

FIG. 4 shows signal timings and voltages of the falling reset driver during the preset period according to an exemplary embodiment of the present invention, and FIG. 5 and FIG. 6 shows a current path of the falling reset driver in each period shown in FIG. 4.

In FIG. 4, the control signal S2 is applied to the gates of the transistors Ypn1 and Ypn2, and the control signal S1 is applied to the gate of the transistor YscL. When the voltages of the control signals S2 and S1 are high level, the transistors Ypn1, Ypn2, and YscL are turned on, and when the voltages of the control signals S2 and S1 are low level, the transistors Ypn1, Ypn2, and YscL are turned off.

Referring to the driving waveforms of FIG. 2, the voltage of the Y electrode before the operation of the falling reset driver 420 is assured to be set to 0 V, and the transistor SL of the scan circuit 412 is turned on during the preset period, and thus the voltage of the Y electrode is set to the voltage of the low voltage terminal of the scan circuit 412.

First, the transistor YscL is turned on by the control signal S1, and thus the first falling period Tf1 of the preset period begins. As shown in FIG. 5, when the transistor YscL is turned on, the voltage of the Y electrode is gradually decreased through a current path formed from the low voltage terminal OUTL, a body diode of the transistor Ypn2, the capacitor Css, the diode Dfr, the transistor YscL to the power source VscL. In this case, the capacitor Css is charged with a voltage, and a voltage VL of the low voltage terminal OUTL may be decreased to a voltage equal to the voltage VscL+voltage of the capacitor Css, e.g., a voltage of VscL/2 due to the capacitor Css.

Further, when the transistor YscL is turned on, and thus a drain voltage Vd of the transistor YscL becomes the voltage VscL, a source voltage of the transistor Yfr becomes the voltage VscL. In this case, when the transistor Yfr is set to be turned on depending on the source voltage, the transistor Yfr is turned on depending on the source voltage and the second falling period Tf2 begins.

When the transistor Yfr is turned on, no more current flows through a current path formed from the transistor Ypn2, the capacitor Css to the diode Dfr, and as shown in FIG. 5, the voltage VL of the low voltage terminal OUTL is gradually decreased to the voltage VscL through a current path formed from the low voltage terminal OUTL and the transistors Yfr and YscL to the power source VscL during the second falling period Tf2.

As described, after the voltage VL of the low voltage terminal OUTL has been decreased to the voltage VscL during the second falling period Tf2, the first rising period Tr1 begins in which the voltage of the Y electrode is increased to the ground voltage for the operation during a rising period of the reset period.

The first rising period Tr1 begins when the transistor Ypn2 is turned on by the control signal S2.

When the transistor Ypn2 is turned on, a current path is formed from the power source VscL, the diode Dpn2, the capacitor Css, and the transistor Ypn2 to the low voltage terminal OUTL as shown in FIG. 6, and the voltage VL of the low voltage terminal OUTL is gradually increased from the voltage VscL to a voltage of VscL/2 through the current path by the voltage charged in the capacitor Css.

Next, the transistor Ypn1 is turned on after a set or predetermined time gap after the transistor Ypn2 is turned on, and accordingly, the second rising period Tr2 begins. In this case, the voltage VL of the low voltage terminal OUTL may be maintained with the VscL/2 voltage during a set or predetermined time period according to a turn-on time of the transistor Ypn1.

When the transistor Ypn1 is turned on, a current path is formed from the ground terminal, the diode Dg, and the transistor Ypn1 to the low voltage terminal OUTL as shown in FIG. 6, and the voltage VL of the low voltage terminal OUTL may be increased to the ground voltage from the VscL/2 voltage through the current path.

Here, the transistor Yfr is substantially in the turn-off state during the first falling period Tf1, and the drain voltage of the transistor YscL is gradually decreased to the VscL voltage from the voltage equal to voltage VscL+voltage of the capacitor Css, e.g., the VscL/2 voltage. Thus, the drain-source voltage of the transistor YscL is gradually decreased from the |VscL/2| voltage to 0 V during the first falling period Tf1, and accordingly, power P1 consumed during the first falling period Tf1 is represented by Equation 5. During the second falling period Tf2, the drain-source voltage of the transistor YscL is 0 V and the transistor Yfr is turned on such that the drain-source voltage of the transistor Yfr is gradually decreased to 0 V from the voltage of the capacitor Css, e.g., the |VscL/2| voltage. Accordingly power P2 consumed during the second falling period Tf2 is represented by Equation 6.

i) P1=½*Cp*(VscL/2)² [Equation 5]

i) P2=½*Cp*(VscL/2)² [Equation 6]

In addition, while the transistor Ypn2 is turned on during the first rising period Tr1, the drain voltage is gradually increased from the VscL voltage to the voltage equal to the voltage of the capacitor Vss+the VscL voltage, e.g., the VscL/2 voltage. Accordingly, power P3 consumed during the first rising period Tr1 is represented by Equation 7. Thus, the drain-source voltage of the transistor Ypn1 is gradually increased from the VscL/2 voltage to 0 V during the second rising period Tr2, and accordingly power P4 consumed during the second rising period Tr2 is represented by Equation 8.

i) P3=½*Cp*(−VscL/2)² [Equation 7]

i) P4=½*Cp*(−VscL/2)² [Equation 8]

Accordingly, power P5 consumed by the transistors YscL, Yfr, Ypn1, and Ypn2 during the reset period is represented by Equation 9.

i) P5=P1+P2+P3+P4=½*Cp*(VscL)² [Equation 9]

In a comparative example, when the voltage of the Y electrode is gradually decreased to the VscL voltage from 0 V using one transistor and the voltage of the Y electrode is gradually increased from the VscL voltage to 0 V using the other transistor during the preset period, a drain-source voltage of a transistor for gradually decreasing the voltage of the Y electrode from 0 V to the VscL voltage is gradually decreased from 0 V to the VscL voltage. Therefore, power P6 consumed by the transistor is represented by Equation 10. In addition, the drain-source voltage of the transistor for gradually increasing the voltage of the Y electrode from the VscL voltage to 0 V is gradually increased from the YscL voltage to 0 V. Therefore, power P7 consumed through the transistor is represented by Equation 11.

i) P6=½*Cp*(VscL)² [Equation 10]

i) P7=½*Cp*(−VscL)² [Equation 11]

That is, when the voltage of the Y electrode is gradually decreased from 0 V to the VscL voltage using one transistor and the voltage of the Y electrode is gradually increased from the VscL voltage to 0 V using the other transistor during the preset period, power P8 consumed in this case is represented by Equation 12, and the power P8 is higher than the power P5 consumed by the transistors YscL, Yfr, Ypn1, and Ypn2 during the preset period of the reset period.

i) P8=P6+P7=Cp*(VscL)²>P5 [Equation 12]

As described in the above embodiment, the transistors YscL, Yfr, Ypn1, Ypn2 have relatively low heat dissipation amount, and therefore a heat sink attached to the transistors YscL, Yfr, Ypn1, and Ypn2 can be made slim, and accordingly the plasma display can be slim.

For example, when Cp=200 nF and VscL=−200 V, P8=8 mW by Equation 12, and when the corresponding reset pulse is applied 12 times for each field and 1 second has 60 fields, P8 (loss in 1 second)=8 mW*12*60=5.76 W, but P5 (loss of 1 second)=2.88 W. That is, 2.88 W can be saved.

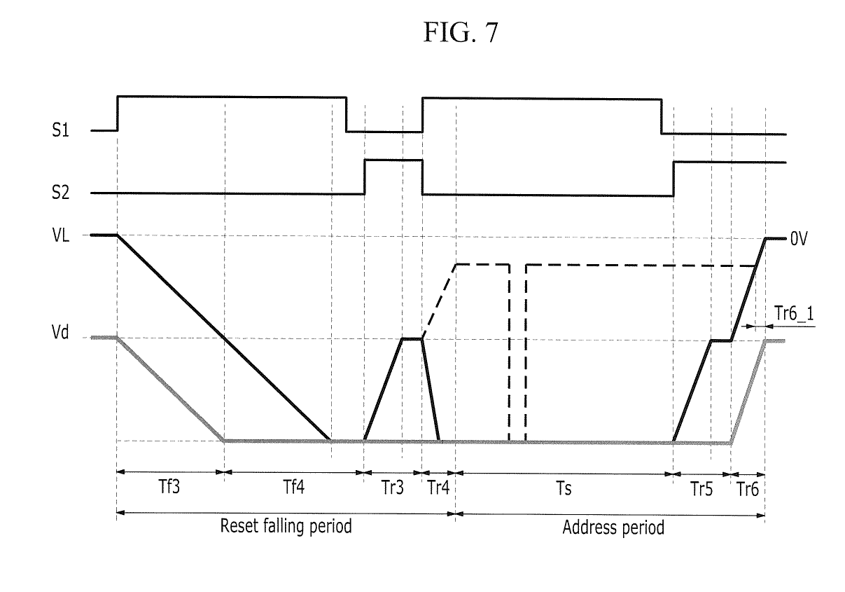

FIG. 7 shows signal timings and voltages of the scan driver and the falling reset driver during the falling period of the reset period and the address period according to an exemplary embodiment of the present invention.

It is assumed that the voltage of the Y electrode before the operation of the falling period of the reset period is 0 V with reference to the driving waveform of FIG. 2. In addition, the transistor SL of the scan circuit 412 is turned on during the falling period of the reset period, and thus the voltage of the Y electrode is set to a voltage of the low voltage terminal of the scan circuit 412.

First, the transistor YscL is turned on by the control signal S1, and thus the first falling period Tf3 of the falling period begins. Then, as shown in FIG. 5, the voltage VL of the low voltage terminal OUTL may be decreased to the voltage VscL/2 through a current path formed from the low voltage terminal OUTL, the body diode of the transistor Ypn2, the capacitor Css, the diode Dfr, and the transistor YscL to the power source VscL.

In addition, when the transistor YscL is turned on and thus the drain voltage Vd of the transistor YscL becomes the VscL voltage, the gate-source voltage of the transistor Yfr exceeds the threshold voltage, and thus the transistor Yfr is turned on and the second falling period Tf4 begins.

When the transistor Yfr is turned on, the voltage VL of the low voltage terminal OUTL is gradually decreased to the VscL voltage during the second falling period Tf4 through the current path formed from the low voltage terminal OUTL and the transistors Yfr and YscL to the power source VscL as shown in FIG. 5.

After the voltage VL of the low voltage terminal OUTL has been decreased to the VscL voltage during the falling period of the reset period, a first rising period Tr3 begins in which the voltage of the Y electrode is increased to the VscH voltage for the operation of the address period.

The first rising period Tr3 begins when the transistor Ypn2 is turned on by the control signal S2.

When the transistor Ypn2 is turned on, the voltage VL of the low voltage terminal OUTL is increased from the VscL voltage to the VscL/2 voltage by the voltage charged in the capacitor Css through a current path formed from the power source VscL, the diode Dpn2, the capacitor Css, and the transistor Ypn2 to the low voltage terminal OUTL as shown in FIG. 6.

Next, the control signal S2 becomes low level and the control signal S1 becomes high level before the transistor Ypn2 is turned on by the control signal S2. Then, the transistor Ypn2 is turned off and the transistor YscL is turned on such that the second rising period Tr4 begins.

During the second rising period Tr4, the transistor YscL is turned on, and the transistors SL of the plurality of scan circuits 412 are turned off and the transistors SH of the respective scan circuits 412 are turned on. Then, the voltage VL of the low voltage terminal OUTL is decreased to the voltage VscL, and the voltage of the Y electrode is set to the voltage of the high voltage terminal OUTH and thus is increased to the voltage VscH.

When the voltage of the low voltage terminal OUTL of the scan circuit 412 becomes the VscL voltage, a scan period Ts of the address period begins.

During the scan period Ts, the transistors SL of the plurality of scan circuits 412 are sequentially turned on such that the plurality of scan circuits 412 sequentially apply the voltage VscL of the low voltage terminal OUTL to the plurality of Y electrodes. The transistor SH of a scan circuit 412 of which the transistor SL is not turned on among the plurality of scan circuits 412 is turned on, and thus the voltage VscH of the high voltage terminal OUTH is applied to the corresponding Y electrode.

During the scan period Ts, the VscL voltage is sequentially applied to the plurality of Y electrodes, and then the first rising period Tr5 begins in which the voltage of the Y electrode is increased to the ground voltage for the operation of the sustain period.

The first rising period Tr5 begins when the control signal S1 becomes low level and the control signal S2 becomes high level.

During the first rising period Try, the two transistors SH and SL of each of the plurality of scan circuits 412 are turned off, and the transistor Ypn2 is first turned on by the control signal S2. Then, the voltage VL of the low voltage terminal OUTL is increased from the voltage VscL to the VscL/2 voltage by the voltage charged in the capacitor Css. In this case, the voltage of the Y electrode is maintained at the voltage VscH.

Next, when the transistor Ypn2 is turned on, the transistor Ypn1 is turned on after a set or predetermined time gap from the turn-on time of the transistor Ypn2, and then the second rising period Tr6 begins. When the transistor Ypn1 is turned on, as shown in FIG. 6, the voltage VL of the low voltage terminal OUTL is increased from the VscL/2 voltage to the ground voltage through a current path formed from the ground terminal, the diode Dg, and the transistor Ypn1 to the low voltage terminal OUTL. In this case, during a period Tr6_1 during which the voltage VL of the low voltage terminal OUTL is higher than the VscH voltage, the voltage of the Y electrode is increased to the ground voltage from the VscH voltage through a body diode of the transistor SL of each of the plurality of scan circuits 412.

Here, power P9 consumed during the first falling period Tf3 may be represented by Equation 5, and power P10 consumed during the second falling period Tr4 may be represented by Equation 6. In addition, power P11 consumed during the first rising period Tr3 is represented by Equation 7. Since the transistors Ypn1 and Ypn2 are turned off and the transistor SH of the scan circuit 412 is turned on and thus the voltage of the Y electrode is increased to the VscH voltage during the second rising period Tr4, power P12 consumed by the transistor SH of the scan circuit 412 during the second rising period Tr4 is represented by Equation 13.

i) P12=½*Cp*(VscL/2−VscH)² [Equation 13]

After termination of the scan period Ts, power is consumed only in the period Tr6_1 during the first rising period Tr5 and the second rising period Tr6. Power consumed during the period Tr6_1 is represented by Equation 14.

i) P13=½*Cp*(VscH)² [Equation 14]

Thus, power P14 consumed by the transistors YscL, Yfr, Ypn1, Ypn2, and SH during the falling period of the reset period and the address period is represented by Equation 15.

$$\begin{matrix}[ Equation 15 ] & \\ \begin{matrix}P 14 = P 9 + P 10 + P 11 + P 12 + P 13 \\ = 1 / {2}^{*} {{Cp}^{*} ( VscL / 2 )}^{2} + 1 / {2}^{*} {{Cp}^{*} ( VscL / 2 )}^{2} + \\ 1 / {2}^{*} {{Cp}^{*} ( - VscL / 2 )}^{2} + 1 / {2}^{*} {{Cp}^{*} ( VscL / 2 - VscH )}^{2} + \\ 1 / {2}^{*} {{Cp}^{*} ( VscH )}^{2}\end{matrix} & i ) \\ = 1 / {2}^{*} ( {( VscL )}^{2} + 2 {( VscH )}^{2} - ( {VscL}^{*} VschH ) ) & ii )\end{matrix}$$

However, in a comparative example, when the voltage of the Y electrode is gradually decreased from 0 V to the VscL voltage using only one transistor, the voltage of the Y electrode is gradually increased from the VscL voltage to the VscH voltage using the other transistor during the falling period of the reset period, and the voltage of the Y electrode is increased from the VscH voltage to 0 V during the address period, a drain-source voltage of a transistor for gradually decreasing the voltage of the Y electrode from 0 V to the VscL voltage is gradually decreased from 0 V to the VscL voltage. Therefore, power P15 consumed by the transistor is represented by Equation 10. After that, a drain-source voltage of a transistor for gradually increasing the voltage of the Y electrode from the VscL voltage to the VscH voltage is increased from the VscL voltage to the VscH voltage, and power P16 consumed by the transistor is represented by Equation 16. In addition, a drain-source voltage of a transistor for gradually increasing the voltage of the Y electrode from the VscH voltage to 0 V is increased from the voltage VscH to 0 V. Therefore, power P17 consumed by the transistor is represented by Equation 17.

i) P16=½*Cp*(VscH−VscL)² [Equation 16]

i) P17=½*Cp*(VscH)² [Equation 17]

That is, power P18 consumed during the reset period and the address period is represented by Equation 18, and the power P18 is greater than the power P14 consumed by the transistors YscL, Yfr, Ypn1, Ypn2, and SH during the reset period and the address period.

i) P18=P15+P16+P17=½*Cp*(VscL)²+½*Cp*(VscH−VscL)²+½*Cp*(VscH)²>P14 [Equation 18]

As described in the above embodiment, heat dissipation of the transistors YscL, Yfr, Ypn1, Ypn2, and SH is low, and therefore a heat sink attached to the transistors YscL, Yfr, Ypn1, Ypn2, and SH can be made slim, and accordingly the plasma display can be slim.

For example, when Cp=200 nF, VscL=−200 V, and VscH=−40 V, P14=½*Cp*((VscL)²+2(VscH)²−(VscL*VscH))=3.52 mW and P18=½*Cp*(VscL)²+½*Cp*(VscH−VscL)²+½*Cp*(VscH)²=6.6 mW such that 3.08 mW can be saved. In this case, the present waveform is applied 10 times for each field and 1 second is formed of 60 fields, therefore, approximately 1.85 W can be saved. When 1.85 W is added with the difference between the power P5 and the power P6, a total of 4.73 W can be saved. Because a reset pulse is always applied unlike a sustain pulse, an average power consumption of 4.73 W can be saved in every subfield.

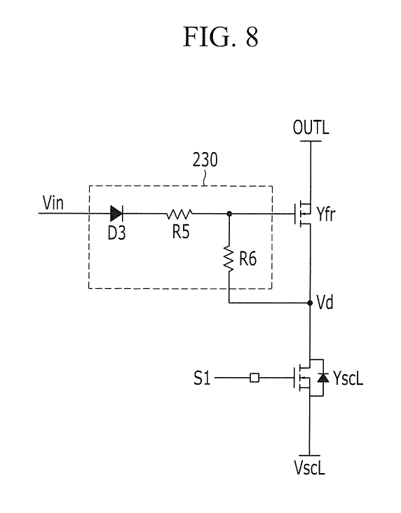

Next, a method for controlling the driving of the transistor Yfr will be described with reference to FIG. 8.

FIG. 8 shows a gate driver of the transistor Yfr of FIG. 3.

A gate driver 230 shown in FIG. 8 is exemplarily provided to control turn-on/turn-off of the transistor Yfr as an additional gate integrated circuit (IC) to thereby minimize cost increase of the plasma display. Referring to FIG. 8, the gate driver 230 may include a diode D3 and resistors R5 and R6.

An anode of the diode D3 is connected to a power source Vin for supplying an input voltage, a cathode of the diode D3 is connected to one terminal of the resistor R5, and the other terminal of the resistor R5 is connected to the gate of the transistor Yfr. In addition, the resistor R6 is connected between the gate and the source of the transistor Yfr. For example, when the input voltage is about 15V, a ratio between the resistor R5 and the resistor R6 is 1:1, and a threshold voltage of the transistor Yfr is 5V, the transistor Yfr is set to be turned on with a voltage that is about 5V higher than the VscL voltage. Thus, set values of the resistors R5 and R6 are changed depending on the transistor Yfr.

The value of the resistor R6 should be small enough not to turn on the transistor Yfr by a gate-drain capacity, and the value is generally not greater than 10 kOhm. The value of the resistor R5 may be changed according to a control speed of the transistor Yfr depending on the resistor R6 and the input voltage Vin, and therefore, the value of the resistor R5 may be set depending on an experiment rather than having a specific value.

Therefore, when the drain voltage Vd of the transistor VscL is the VscL voltage, the gate driver 230 turns on the transistor Yfr, and the drain voltage Vd of the transistor VscL is higher than the VscL voltage, the gate driver 230 turns off the transistor Yfr. In this case, the transistor Yfr can be controlled to be turned on in a linear area, and the voltage slope can be controlled using the transistor Yfr when the turn-on and the turn-off are performed very fast.

According to the exemplary embodiments of the present invention, power consumption of a transistor can be reduced, and accordingly, heat dissipation of the transistor also can be reduced.

The above-described exemplary embodiments of the present invention may be realized not only through a device or method, but also through a program or program-recorded medium with functions corresponding to the structures thereof, and as those skilled in the art would realize, such a realization may be easily made from the described embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A plasma display comprising:
a scan electrode;
a scan circuit comprising a high voltage terminal and a low voltage terminal, and being configured to set a voltage of the scan electrode as a voltage of the high voltage terminal or a voltage of the low voltage terminal;
a first transistor coupled between the low voltage terminal and a first power source configured to supply a first voltage, and having a first terminal of which a voltage corresponds to the voltage of the scan electrode and a second terminal of which a voltage corresponds to the first voltage; and
a falling reset driver comprising a second transistor coupled in series with the first transistor between the low voltage terminal and the first terminal of the first transistor, a third transistor coupled between the first terminal of the first transistor and the low voltage terminal, and a first capacitor,
wherein the falling reset driver is configured to gradually decrease the voltage of the scan electrode to a second voltage that is higher than the first voltage through the first capacitor by turning on the first transistor during a first falling period of a first period of a reset period, and gradually decrease the voltage of the scan electrode to the first voltage by concurrently turning on the first transistor and the second transistor during a second falling period of the first period.

2. The plasma display of claim 1, further comprising a first gate driver configured to turn on the second transistor depending on a voltage of the first terminal of the first transistor.

3. The plasma display of claim 1, wherein the falling reset driver is configured to gradually increase the voltage of the scan electrode to the second voltage through the first capacitor by turning on the third transistor during a first rising period after the second falling period in the first period.

4. The plasma display of claim 3, wherein the falling reset driver further comprises a fourth transistor coupled between the low voltage terminal and a second power source configured to supply a third voltage that is higher than the first voltage, the fourth transistor being configured to increase the voltage of the scan electrode from the second voltage to the third voltage by turning on the fourth transistor during a second rising period after the first rising period in the first period.

5. The plasma display of claim 4, further comprising:
a first gate driver configured to turn on the third transistor by a control signal during the first rising period; and
a second gate driver configured to turn on the fourth transistor by the control signal during the second rising period.

6. The plasma display of claim 5, wherein
the third transistor has a control terminal, a first terminal coupled to the low voltage terminal, and a second terminal coupled to the first terminal of the first transistor,
the fourth transistor has a control terminal, a first terminal coupled to the low voltage terminal, and a second terminal coupled to the second power source,
the first gate driver has a first input terminal for receiving the control signal, a first resistor coupled between the control terminal of the third transistor and the first input terminal, and a second capacitor coupled between the control terminal of the third transistor and the second terminal of the third transistor,
the second gate driver has a second input terminal for receiving the control signal, a second resistor coupled between the control terminal of the fourth transistor and the second input terminal, and a third capacitor coupled between the control terminal of the fourth transistor and the second terminal of the fourth transistor, and
a value of at least one of the first resistor and the second capacitor is different from values of the second resistor and the third capacitor.

7. The plasma display of claim 6, wherein the value of the first resistor is smaller than that of the second resistor.

8. The plasma display of claim 6, wherein the value of the second capacitor is smaller than that of the third capacitor.

9. The plasma display of claim 3, further comprising a second capacitor coupled between the high voltage terminal and the low voltage terminal and configured to store a voltage corresponding to a difference between a third voltage that is higher than the second voltage and the first voltage,
wherein the falling reset driver is configured to set the voltage of the low voltage terminal to the first voltage by turning on the first and second transistors during a second rising period after the first rising period in the first period, and
the scan circuit is configured to set the voltage of the scan electrode to the voltage of the high voltage terminal to increase the voltage of the scan electrode to the third voltage during the second rising period.

10. The plasma display of claim 9, wherein the scan circuit comprises a fifth transistor coupled between the low voltage terminal and the scan electrode and a sixth transistor coupled between the high voltage terminal and the scan electrode, the scan circuit being configured to turn off the fifth and sixth transistors during a second period before a sustain period during which on-cells are sustain-discharged during an address period during which on-cells and off-cells are selected, and
the falling reset driver is configured to gradually increase the voltage of the scan electrode to the second voltage by turning on the third transistor during a first rising period of the second period, and increase the voltage of the scan electrode to the third voltage by turning on the fourth transistor during a second rising period of the second period.

11. The plasma display of claim 3, wherein the falling reset driver further comprises a first diode of which an anode is coupled to the first power source and a cathode is coupled to the first capacitor.

12. The plasma display of claim 11, wherein the falling reset driver further comprises a second diode of which a cathode is coupled to the first terminal of the first transistor and an anode is coupled to the first capacitor.

13. The plasma display of claim 1, wherein the falling reset driver further comprises a diode configured to block a current path including the first capacitor, the first transistor, and the second transistor.

14. A driving method of a plasma display including a scan electrode, a scan circuit having a high voltage terminal and a low voltage terminal and configured to set a voltage of the scan electrode to a voltage of the high voltage terminal or a voltage of the low voltage terminal, and a first transistor coupled between the low voltage terminal and a first power source configured to supply a first voltage, the method comprising:
electrically connecting the low voltage terminal to the scan electrode during a first period of a reset period;
gradually decreasing the voltage of the scan electrode to a second voltage that is higher than the first voltage through a capacitor coupled between the low voltage terminal and the first transistor by turning on the first transistor during a first falling period in the first period; and
gradually decreasing the voltage of the scan electrode from the second voltage to the first voltage by concurrently turning on the first transistor and a second transistor coupled between the low voltage terminal and the first transistor during a second falling period in the first period.

15. The driving method of the plasma display of claim 14, further comprising:
increasing the voltage of the scan electrode to the second voltage through the capacitor during a first rising period after the second falling period in the first period; and
electrically connecting the high voltage terminal to the scan electrode and increasing the voltage of the scan electrode to a third voltage during a second rising period in the first period.

16. The driving method of the plasma display of claim 15, wherein the increasing to the third voltage comprises setting a voltage of the low voltage terminal to the first voltage through the first and second transistors.

17. The driving method of the plasma display of claim 14, further comprising:
gradually increasing the voltage of the scan electrode to the second voltage through the capacitor during a first rising period after the second falling period in the first period; and
gradually increasing the voltage of the scan electrode to the third voltage through a second power source configured to supply the third voltage that is higher than the first voltage during a second rising period in the first period.

18. The driving method of the plasma display of claim 17, wherein the gradually increasing to the second voltage comprises increasing the voltage of the scan electrode to the second voltage through energy stored in the capacitor by turning on a third transistor coupled between the capacitor and the low voltage terminal, and
the increasing to the third voltage comprises increasing the voltage of the scan electrode to the third voltage by turning on a fourth transistor coupled between the third power source and the low voltage terminal.

19. The driving method of the plasma display of claim 18, wherein the gradually increasing to the second voltage further comprises applying a control signal to a control terminal of the third transistor during the first rising period, and
the increasing to the third voltage further comprises applying the control signal to a control terminal of the fourth transistor during the second rising period by delaying the control signal.

20. The driving method of the plasma display of claim 14, further comprising:
setting the scan circuit to a high impedance state during a second period of an address period during which on cells and off-cells are selected before a sustain period during which on cells are sustain-discharged;
gradually increasing the voltage of the scan electrode to the second voltage through the capacitor during a first rising period in the second period; and
increasing the voltage of the scan electrode to the third voltage through a second power source configured to supply the third voltage that is higher than the first voltage during a second rising period in the second period.
